(19) United States
(12) Patent Application Publication
(10) Pub. No.: US 2008/0000360 A1
(43) Pub. Date: Jan. 3, 2008

(54) Multi-functional side oven structure

(76) Inventor: Lucas Pai, Taichung City (TW)

Correspondence Address: EGBERT LAW OFFICES, 412 MAIN STREET, 7TH FLOOR, HOUSTON, TX, 77002, US

(21) Appl. No.: 11/477,206

(22) Filed: Jun. 29, 2006

(51) Int. Cl. A47J 27/00

(52) U.S. Cl. 99/445

(57) ABSTRACT

The present invention provides a structure of a multi-functional side oven. One end of the housing of the side oven has a connecting end that connects with the main oven. A containment space is placed inside the housing, and the top surface of the housing has an opening that connects with the containment space. The side oven of the present invention has a base tray, a frame base, a grate and a lid. The grate can be used for grilling, and the frame base can be used to place pots and a pitcher for boiling. The lid can be used for smoking, which makes the side oven achieve multiple functions.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an oven, and more particularly to a side oven that has multiple functions.

### BACKGROUND OF THE INVENTION

Today, people are more involved in outdoor activities, and the demand for outdoor accessories and products is increasing. Among outdoor activities, barbeque is one of the most common ones, and industries have responded to the demand with many different types of grills.

The conventional grill has many different structures depending upon the functions, such as a table top, floor grill, and oven bake style. The grill that the present invention desires to improve is shown in FIG. 1, which is a floor type. The entire structure consists of a main oven 10 and a side oven that is placed on the side (one side or both sides) of the main oven 10. The present invention desires to improve the structure of the side oven 11, and its conventional structure is shown in FIG. 1. The side oven 11 is usually designed like a tray 12 with the side oven 11 on the left side of the main oven 10, or a grate 13 with the side oven 11 on the right side of the main oven 10. The structure of the conventional side oven 11 still has problems as follows.

The grill with the main oven 10 and side oven 11 is widely used for grilling by many people. Because of the capacity for a large quantity of food and the variety of food preparing methods, such as bake, grill, smoke or boil, flexibility is a most important factor that affects the practicality of the entire grill. However, the conventional side oven 11 can only be a tray 12 or grate 13; therefore, it can only provide one type of food preparation and obviously can not meet the multiple demands of users. The conventional side oven is not practical.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The side oven A disclosed in the present invention has a base tray 50, a frame base 60, a grate and a lid 80. The grate 70 can be used for grilling, and the frame base 60 can be used to place pots and a pitcher for boiling. The lid 80 can be used for smoking, which makes the side oven A achieve multiple functions.

Moreover, slanted oil grooves 72 and oil holes 73 are formed between the through hole 71. The top surface 23 of the housing 20 corresponds to oil guide surface 26 and oil hole 27. The containment space 22 of the housing 20 corresponds to the oil feeder 25, so that the grease from the grilling drips to the oil hole 73 from the oil groove 72, down to the oil guide surface 26 at the top surface 23 of the housing 20, and down to the oil feeder 25 by the containment space 22 through the oil hole 27 of the oil guide surface 26. By so doing, messy situation from grease dripping down everywhere is avoided. The grease may be cleaned up from the oil feeder 25.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the convention grill.

FIG. 2 shows a perspective view of the preferred embodiment of the side oven of the present invention, in which the lid is closed.

FIG. 3 shows a perspective view of the preferred embodiment of the side oven of the present invention, in which the lid is opened.

FIG. 4 shows an exploded perspective view of the preferred embodiment of the side oven of the present invention.

FIG. 5 shows a sectional view of the grate across line B-B in the FIG. 4.

FIG. 6 shows a schematic view of the side oven and the main oven of the first embodiment.

FIG. 7 shows another schematic view of the side oven and the main oven of the first embodiment.

FIG. 8 shows a perspective view of the operation of the side oven of the present invention.

FIG. 9 shows a sectional view of the operation of the side oven of the present invention.

FIG. 10 shows a sectional view of the operation of the side oven of the present invention.

FIG. 11 shows another sectional view of the operation of the side oven of the present invention.

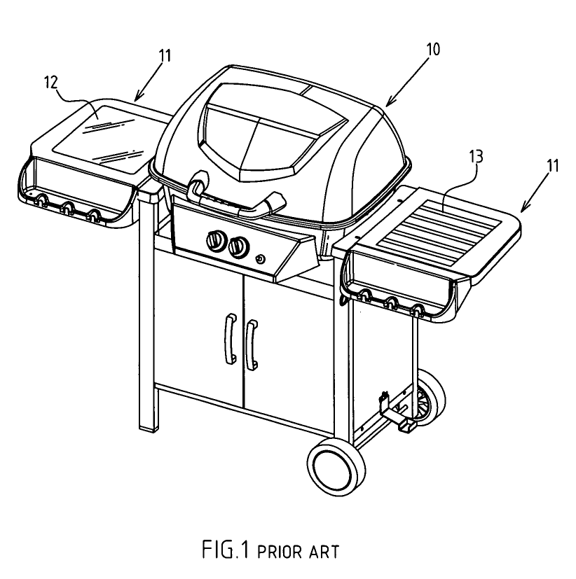

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

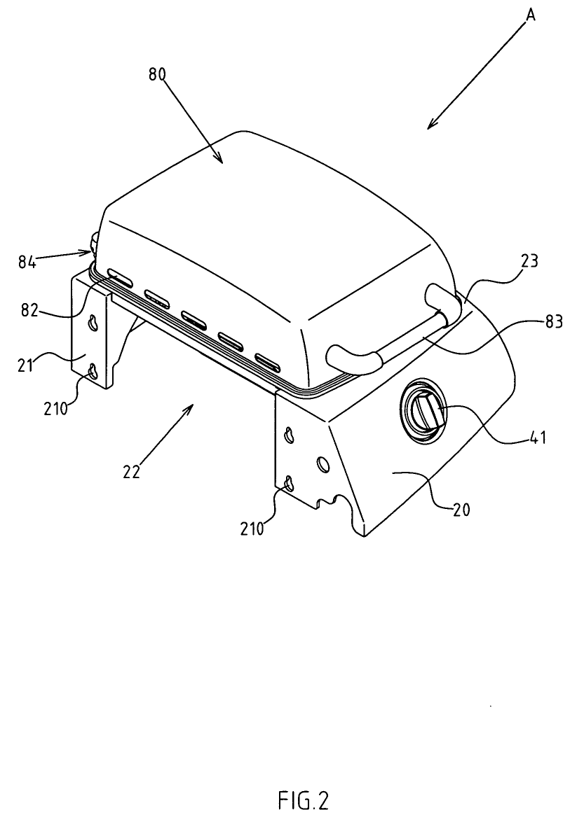

As shown in FIGS. 2, 3, 4, the preferred embodiment of the multi-functional side oven and the side oven A is shown.

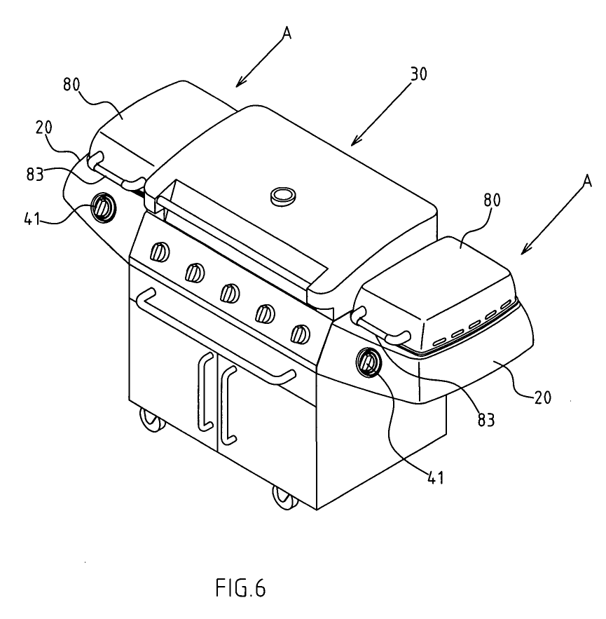

A housing 20 has a connecting end 21 on its external side, which can be connected to the side of the main oven 30. As shown in FIG. 6, the connected state is between the side oven A and the main oven 30. The inside of the housing 20 has containment space 22, and an opening 24 is placed on the top surface 23 of the housing 20 that can be connected to the containment space 22.

A burner 40 can be placed inside the containment space 22 of the housing 20, and the burner 40 can be ignited by a switch 41 on the outside of the housing 20.

A base tray 50 can be placed inside the opening 24 of the top surface of the housing 20, and the base tray 50 includes a groove 51 and a frame edge 52.

A frame base 60 is placed on the groove 51 of the base tray 50, and the frame base 60 includes a frame 61 and several stands 62 inside the frame 61.

A grate 70 is placed on the opening 24 of the housing 20,corresponding to the base tray 50, frame base 60, and the grate 70 having several through hole 71.

A lid 80 is placed on the top surface 23 of the housing 20 and can be opened or closed. The lid 80 has a lid space 81 that is higher than the top surface 23 of the housing 20, and the lid space 81 has several air holes 82. A handle 83 is placed on the predetermined area on the lid 80.

The connecting end 21 of the housing 20 has several connector holes 210, as shown in FIG. 2.

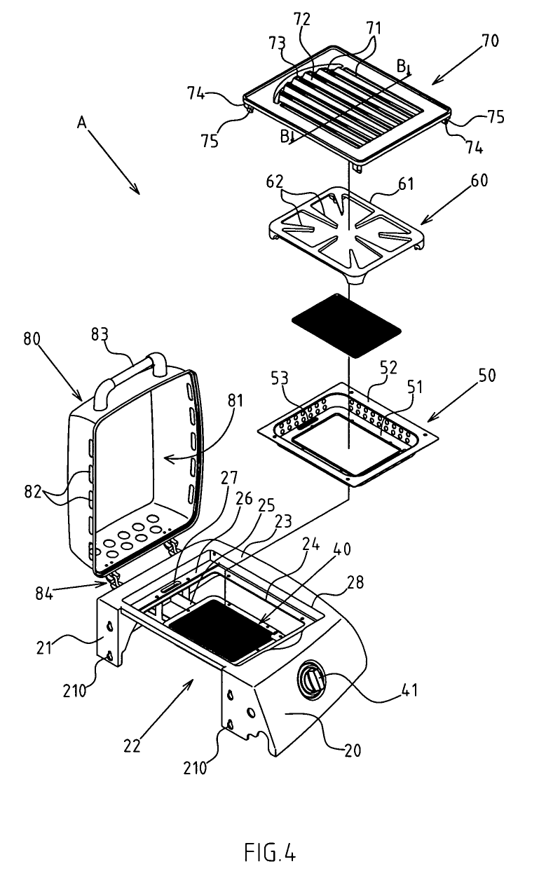

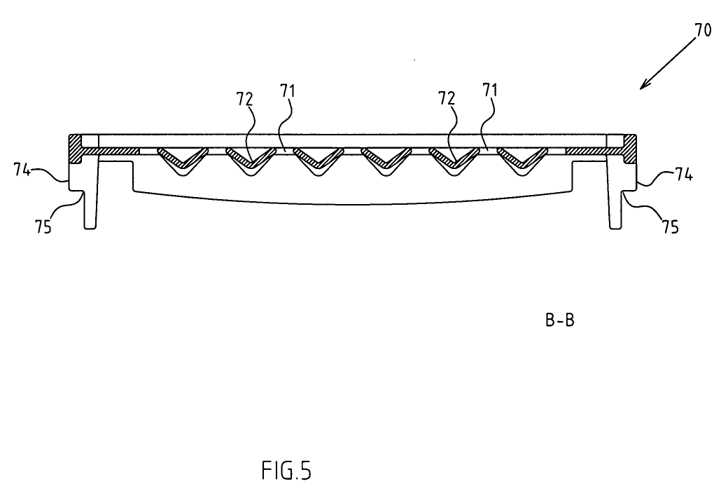

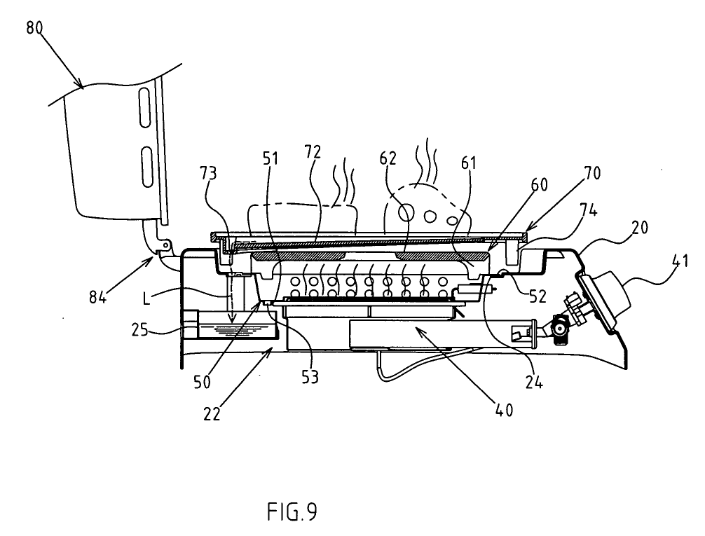

An oil hole 53 can be placed on a predetermined area on the groove 51 of the base tray 50, so that a oil feeder 25 can be placed on the place corresponding to the containment space 22 of the housing 20. The through hole 71 of the grate 70 can have a long block shape, and the through holes 71 are spaced in parallel. The oil groove 72, as shown in FIG. 5, is formed between the through hole 71. Each oil groove 72 is spaced in a slanted position through one end of through hole 71, as shown in FIGS. 4 and 9. An oil hole 73 is placed at the lower end of the oil groove 72, so that the place where the top surface 23 of the housing 20 corresponds to the oil hole 73 has a oil guide surface 26 and a oil hole 27. The lower part of the oil hole 27 corresponds to the oil feeder 25 placed at the containment space 22 of the housing 20.

As shown in FIG. 4, all corners of the grate 70 have a connecting foot 74 that extends downward, and the bottom of the connecting foot 74 has a L-shaped edge 75. Thus, the top surface 23 of the housing corresponds to the curved edge 28 for the L-shaped edge of the connecting foot 74 to connect.

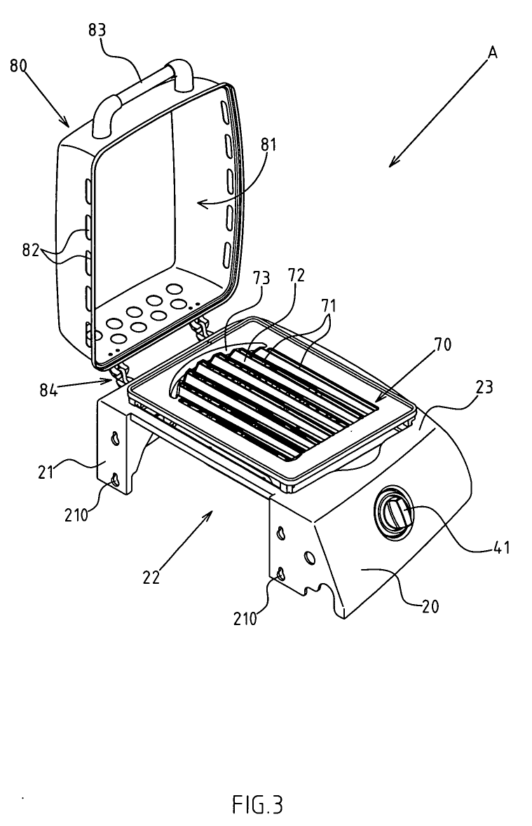

The lid 80 can be in an oscillating movement, which makes one side of the lid 80 correspond to the side of the housing 20 through the connecting component 84. The lid 80 can be placed over the top surface 23 of the housing 20, as shown in FIG. 2, or opened from the top, as shown in FIG. 3.

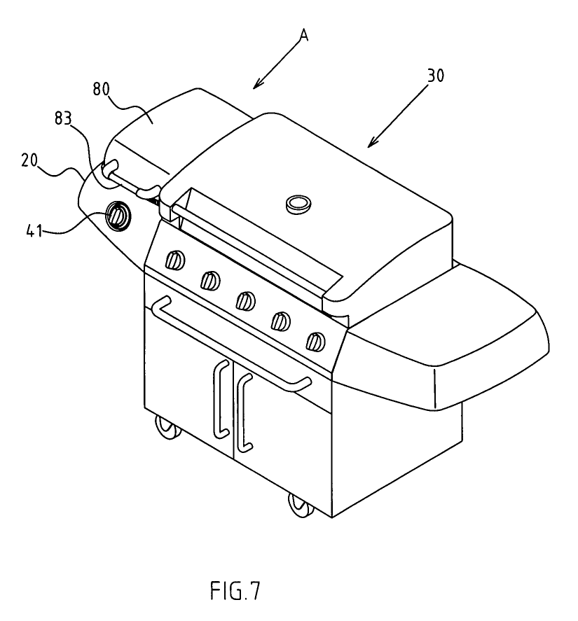

As shown in FIG. 6, there is one of the embodiment of the connected state of the side oven A and the main oven 30. The side oven A of the present invention can be connected to both the right side and the left side of the main oven 30. As shown in FIG. 7, the second embodiment of the connected state of the side oven A and the main oven 30 is shown. The side oven A, in this embodiment, is placed on the one side of the main oven 30 in the single setting.

Through the above structure and design, the main core of the present invention is to differentiate the side oven A from the conventional structure. The side oven A consists of a base tray 50, a frame base 60, a grate 70 and a lid 80. By so doing, multiple options are provided to prepare food, as follows.

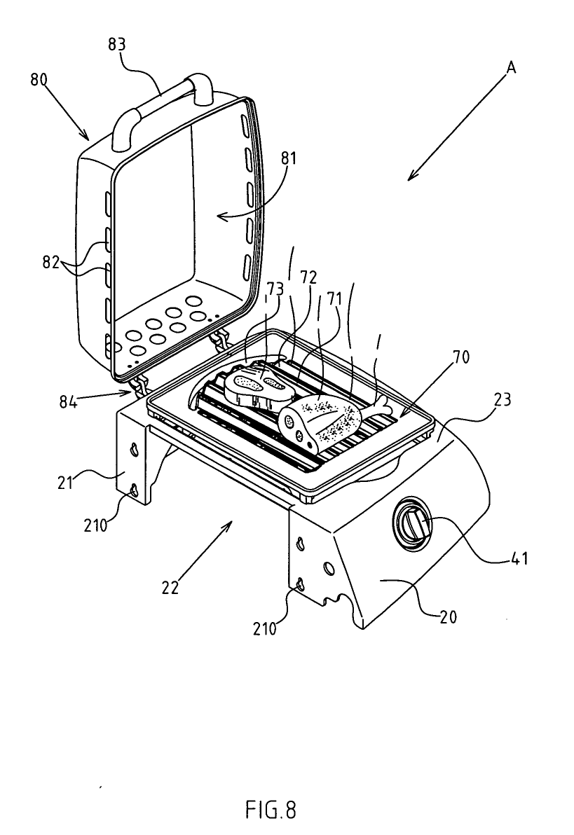

As shown in FIG. 8 and 9, when the grate 70 is connected regularly, the users may use the grate 70 to grill foods, such as grill meat and sausages. During this process, the grease from the grilling drips to the oil hole 73 from the oil groove 72, down to the oil guide surface 26 at the top surface 23 of the housing 20, and down to the oil feeder 25 by the containment space 22 through the oil hole 27 of the oil guide surface 26. The path is shown by the arrow L in the FIG. 9. By so doing, the messy situation from grease dripping down everywhere is avoided, and the grease may be cleaned up from the oil feeder 25.

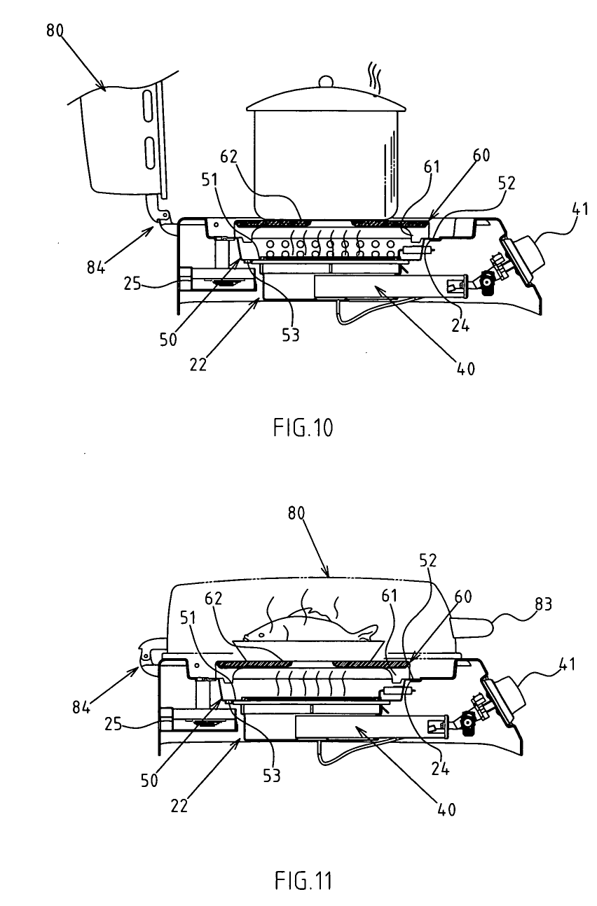

As shown in FIG. 10, the users may take off the grate 70. At this time, the frame base 60 may be used through the frame 61 and stand 62, so that it may be used for pots and pitchers for boiling.

As shown in FIG. 11, users may use a container for food on the frame base 60 and place the lid 80 to cover the top surface 23 of the housing 23. By so doing, the food is heated through the lid space 81 of the lid 80.

I claim:

1. A multi-fuinctional side oven, comprising:
a housing, having a connecting end on an external side thereof, said external side being connected to a side of a main oven, an inside of said housing having containment space, and an opening placed on a top surface thereof, said opening being connected to said containment space;
a burner, being placed inside said containment space of said housing;
a base tray, being placed inside said opening of said top surface of said housing, said base tray being comprised of a groove and a frame edge;
a frame base, being placed on said groove of said base tray, said frame base being comprised of a frame and several stands inside said frame;
a grate, being placed on said opening of said housing corresponding to said base tray, said frame base and said grate having several through holes; and
a lid, being placed on said top surface of said housing, said lid being opened or closed and having a lid space higher than said top surface of said housing, said lid space having several air holes and a handle placed on a predetermined area on said lid.

2. The side oven defined in claim 1, wherein said connecting end of said housing has several connector holes.

3. The side oven defined in claim 1, further comprising:
an oil hole placed on a predetermined area on said groove of said base tray, said containment space having an oil feeder placed on a place corresponding to said containment space, at least one through hole of said grate having a block shape, said through holes being spaced in parallel, said through holes having anoil groove being formed therebetween, each oil groove being spaced in a slanted position through one end of a through hole, said each oil groove having an oil hole at a lower end thereof, said top surface of said housing corresponding to said oil hole having an oil guide surface and a oil hole placed thereon, a lower part of said oil hole corresponding to said oil feeder placed at said containment space of said housing.

4. The side oven defined in claim 1, wherein said grate has corners, each corner having a connecting foot extending downward, a bottom of each connecting foot having a L-shaped edge, said top surface of said housing corresponding to said curved edge for said L-shaped edge of said connecting foot to connect.

5. The side oven defined in claim 1, wherein said lid can be in an oscillating movement, making one side of said lid corresponds to a side of said housing through a connecting component, said lid being placed over said top surface of said housing or able to be opened from said top.
